(19) United States
(12) Patent Application Publication
(10) Pub. No.: US 2002/0189424 A1
(43) Pub. Date: Dec. 19, 2002

(54) Constructive arrangement disposed in a tuning mechanism for percussion instruments

(75) Inventor: Marino Rampazzo Del Valhe, Sao Paulo (BR)

Correspondence Address: STEINBERG & RASKIN, P.C., 1140 AVENUE OF THE AMERICAS, 15th FLOOR, NEW YORK, NY, 10036-5803, US

(73) Assignee: RMV INSTRUMENTOS MUSICAIS LTDA

(21) Appl. No.: 10/173,061

(22) Filed: Jun. 17, 2002

(30) Foreign Application Priority Data
Jun. 18, 2001 (BR) MU-81014201

(51) Int. Cl. G10G 7/02

(52) U.S. Cl. 84/454

(57) ABSTRACT

The invention relates to a constructive arrangement disposed in a tuning mechanism for percussion instruments having a substantially parallel-shaped body (10) having a front face and an upper portion, the front face (1) of said body defining a lower quadrangular recess (2) extending through the parallel-shaped piece (10), said upper portion of said body defining an inverted “T” recess (3), said inverted “T” recess having a horizontal part and a lower part, said lower part of said recess having the same depth of the lower quadrangular recess (2), the vertical and upper part of the inverted “T” recess (3) has a depth which is equivalent to half the depth of the parallel-shaped piece (10).

### FIELD OF THE INVENTION

This invention relates to a constructive arrangement disposed in a tuning mechanism for percussion instruments and, more specifically, to a constructive arrangement provided to the retention element of the tuning stem on the side wall of the percussion instrument, commonly referred to as clamp, which is fastened to the side wall of the instrument box to receive by threading in its upper face the lower end of a tuning stem, the upper end of which is adjustably fitted to the mounting and retaining hoop of the musical instrument skin.

### BACKGROUND OF THE INVENTION

As it is well known by those skilled in the art, all percussion instruments are provided with a tuning mechanism which acts either directly or indirectly upon the instrument's skin in order to stretch it.

Generally, such tuning mechanisms are provided with a piece, commonly referred to as clamp, which is fastened to the outer side of the musical instrument box, such clamp being axially provided with a threaded hole in its upper portion to which the threaded lower end of a stem is adapted, the opposite upper end of such stem being mounted on a hoop which acts directly upon the musical instrument.

Despite being widely used nowadays, such piece referred to as clamp has many inconveniences, being mentioned for instance, the fact that such clamp has a specific fastening way for each model of percussion instrument which requires a great variety of models and sizes of clamps for each particular percussion instrument. Another inconvenience of such conventional piece is that it does not accept any type of radial adjustment in the tuning stem related to the clamp, being its application being so restricted to specific instruments.

Another inconvenience of such conventional piece is its singular and unchangeable finish, which would require the existence of a great number of different models and types of clamps in stock and in the production line being compatible with the quantity of the models and types of instruments in which they are used.

### OBJECTS AND SUMMARY OF THE INVENTION

It is therefore an object of this invention to provide a constructive arrangement disposed in a tuning mechanics for percussion instruments which is provided with a piece referred to as a clamp which can accept an adjustment in the tuning stem in relation to the body of the percussion box, notwithstanding such clamp being fixed together with such box.

Another object of this invention is to provide a constructive arrangement disposed in a tuning mechanism for percussion instruments, which for being adjustable can be used in a number of models of percussion instruments, thus minimizing the variety of models and sizes of clamps required to conform with all models of specific instruments available.

Another object of this invention is to provide a constructive arrangement disposed in a tuning mechanism for percussion instruments, which would accept any type of radial adjustment of the stem relative to the clamp, which makes easier the assembly of the instrument, and the tuning mechanism thereof Another object of this invention is to provide a constructive arrangement disposed in a tuning mechanism for percussion instruments that would have variable finishes allowing the provision of a variety of models and types of clamp finishes for the same tuning mechanism.

These and other objects and advantages of this invention are reached by providing a constructive arrangement disposed in a tuning mechanism for percussion instruments comprising of a substantiality parallel-shaped solid body, which is incorporated in its slightly bulged front face a lower quadrangular recess, such lower quadrangular recess extending almost through the whole depth of the parallel-shaped piece, and an inverted “T” recess in its upper portion, the horizontal and lower part of such recess having the same depth of the lower quadrangular recess, while the vertical and upper part of the inverted “T” recess, it has a depth which is equivalent to half the depth of the parallel-shaped piece, due to the fact that a trough-like insert is centrally and vertically incorporated into the upper middle portion of such piece, such trough-like insert together with the inverted “T” upper recess defining an adjustably fitted bed of an internally threaded tubular sleeve provided with a rectangular base, which is snugly and able to slide fitted into such bed; the end of the tuning stem being axially threaded to said sleeve and such end going through the whole length of the tubular sleeve and being self-threading fastened to the intermediate horizontal wall which is defined between the upper Inverted “T” recess and the lower quadrangular recess, a through-hole being defined in the bottom wall of such lower quadrangular recess coinciding with a tubular projection which extends orthogonally from the back wall of said solid parallel-shaped body, said projection being fitted into a corresponding hole provided in the percussion instrument side wall, both being pierced through by a fastening screw which has a free end disposed into the lower quadrangular recess wherein a check nut is received; the whole assembly which is mounted and adjusted with respect to the percussion instrument is covered with a finish case having a parallel-shape contour with a half-oblong recess disposed in the upper face thereof so as to ensure the press-fit of the finish case to the sound body, such case covering the whole assembly.

### BRIEF DESCRIPTION OF THE DRAWINGS

This invention is described in more detail hereinafter with reference to the accompanying drawings, wherein:

FIG. 1 is a rear perspective view of the tuning mechanism for percussion instruments, according to the new arrangement;

FIG. 2 is a side view of the tuning mechanism for percussion instruments;

FIG. 3 is a perspective exploded and front view of the tuning mechanism, wherein the solid body not provided with the finish case is shown which is then represented beside it;

FIG. 4 is a perspective exploded and front view of the tuning mechanism not provided with the finish case, illustrating the solid body without the adjustably fitted sleeve of the tuning stem end;

FIG. 5 is a perspective view of the percussion instrument provided with the tuning mechanism and the new constructive arrangement thereof

### DETAILED DESCRIPTION OF THE INVENTION

According to the drawings, the constructive arrangement disposed in the tuning mechanism for percussion instruments, object hereof, comprises a solid body 10, which is substantially parallel-shaped, incorporating in its bulged front face 1 a lower quadrangular recess 2, such lower quadrangular recess extending almost through the whole depth of the parallel-shaped piece 10, and an inverted “T” recess 3 in its upper portion, the horizontal and lower part of said recess having the same depth of the lower quadrangular recess 2, while the vertical and upper part of the inverted “T” recess 3 has a depth equivalent to half the depth of the parallel-shaped piece 10, due to the fact that a trough-like insert 4 is centrally and vertically incorporated into the upper middle portion of such piece, such trough-like insert together with the inverted “T” upper recess 3 defining both an adjustable filling bed of a tubular sleeve 11.

Said tubular sleeve 11 is internally threaded and provided with a rectangular base 12, which is snugly and able to slide fitted into such bed 3. To said sleeve 11 the end of the tuning stem, not shown, is axially threaded, said tuning stem end going through the whole length of the tubular sleeve 11 and 12 to self-threading fasten to the intermediate horizontal wall 5 which is defined between the upper inverted “T” recess 3 and the lower quadrangular recess 2.

A through-hole is defined in the bottom wall of the lower quadrangular recess 2 coinciding with a tubular projection 6 which extends orthogonally from the back wall 7 of said solid parallel-shaped body 10, said projection 6 being fitted into a corresponding hole provided in the percussion instrument side wall 20, both being pierced through by a fastening screw 8.

Such fastening screw 8 pierces through the projection 6 and the bottom wall 7, in such a way that its free and threaded end will appear inside the quadrangular recess 2, wherein a check nut 9 is received.

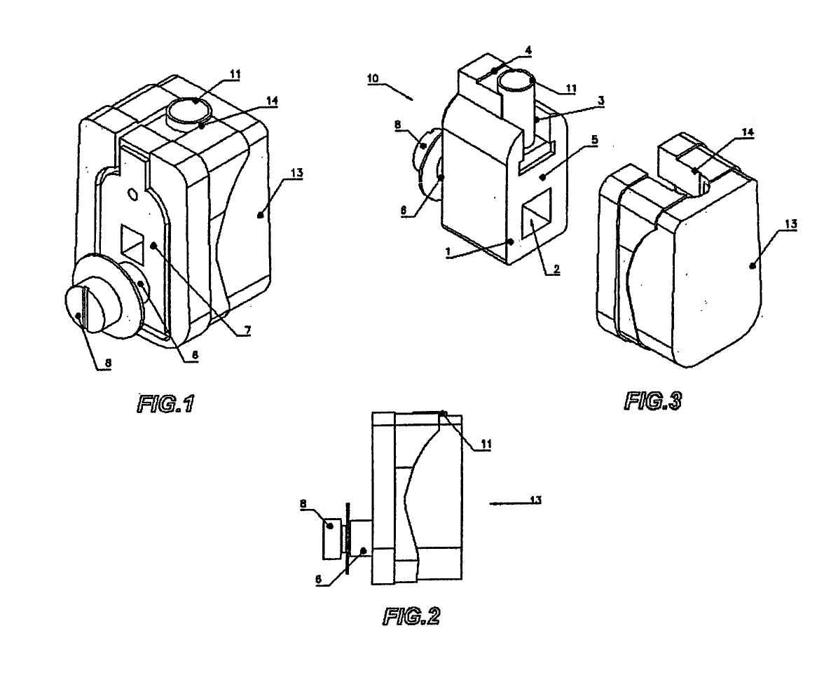

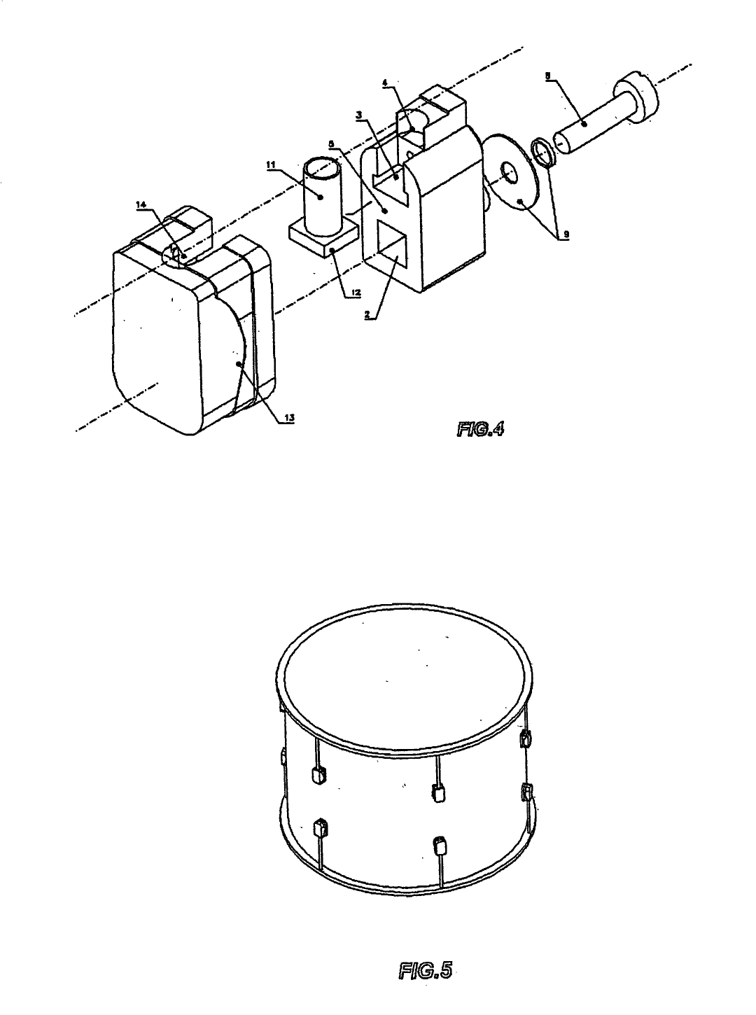

As can be seen in FIGS. 1 and 2, the whole assembly mounted and adjusted with respect to the percussion instrument is covered with a finish case 13 having a parallel-shaped contour with a half-oblong recess 14 in the upper face thereof so as to ensure the press fit of the finish case 13 to the solid body 10, such case covering the whole assembly.

Said finish case 13, preferably made of plastic material may have a metallic, glossy or dull finish, according to the type of plastic and the surface paint provided to it.

As it is a press-fit piece, such case 13 may be replaced at any time and according to the model of the percussion instrument 20 to which the mechanism 10 is employed.

With the foregoing description and illustrations, those skilled in the art will appreciate that modifications may be made to the invention without departing from the scope thereof.

1. Constructive arrangement disposed in a tuning mechanism for percussion instruments, comprising:
a substantially parallel-shaped body (10) having a front face and an upper portion;
said front face (1) of said body defining a lower quadrangular recess (2) extending through the parallel-shaped piece (10);
said upper portion of said body defining an inverted “T” recess (3), said inverted “T” recess having a horizontal part and a lower part, said lower part of said recess having the same depth of the lower quadrangular recess (2), the vertical and upper part of the inverted “T” recess (3) has a depth which is equivalent to half the depth of the parallel-shaped piece (10);
a trough-like insert (4), said trough-like insert (4) is centrally and vertically incorporated into the upper middle portion of such piece, said trough-like insert (4) together with the inverted “T” upper recess (3) defining an adjustably fitted bed of a tubular sleeve (11), said bed of a tubular sleeve (11) is internally threaded, said bed of a tubular sleeve (11) has a rectangular base (12), said rectangular base (12) is fitted into said bed;
an intermediate horizontal wall (5) which is defined between the upper inverted “T” recess (3) and the lower quadrangular recess (2), said intermediate horizontal wall being fastened to an end of a tuning stem, said stem being axially threaded to said sleeve and said end of said tuning stem goes through the length of the tubular sleeve (11, 12);
a through-hole being defined in the bottom wall of the lower quadrangular recess;
a tubular projection which extends orthogonally from a back wall (7) of said solid parallel-shaped body (10), said projection (6) being fitted into a corresponding hole provided in a percussion instrument (20) side wall, both being pierced through by a fastening screw (8), said fastening screw has a free end disposed into the lower quadrangular recess (2) wherein a check nut (9) is received; and
a finish case (13) having a parallel-shape contour defining a half oblong recess (14) disposed in the upper face thereof as to ensure the press-fit of the finish case (13, 14) to the solid body, said finish case covering the arrangement.
